(19) United States
(12) Patent Application Publication
(10) Pub. No.: US 2023/0346150 A1
(43) Pub. Date: Nov. 2, 2023

(54) INTEGRATED MULTIFUNCTIONAL VACUUM COOKING MACHINE

(71) Applicant: GUANGZHOU ARGION ELECTRIC APPLIANCE CO., LTD., Guangzhou (CN)

(72) Inventors: Guoqiang Liang, Guangzhou (CN); Yuanchao Wu, Guangzhou (CN); Zhicun Yin, Guangzhou (CN)

(21) Appl. No.: 18/141,399

(22) Filed: Apr. 29, 2023

(30) Foreign Application Priority Data
Apr. 29, 2022 (CN) 202210478761.2

(51) Int. Cl. A47J 27/00; A47J 36/06; A47J 36/24

(52) U.S. Cl. CPC A47J 27/002; A47J 27/004; A47J 36/06; A47J 36/2483

(57) ABSTRACT

An integrated multifunctional vacuum cooking machine includes a cooking machine body, a heat conducting container, a vacuum pump set, a heating assembly, a temperature measuring assembly, and a control system. The cooking machine body includes a base and a top cover, a chamber recessed downward is formed in a top surface of the base, and the top cover is configured to open and close the chamber. The heat conducting container is disposed in the chamber, and defines a vacuum cavity with the top cover when the top cover closes the chamber. The vacuum pump set is communicated with the vacuum cavity. The heating assembly is configured to heat the vacuum cavity. The temperature measuring assembly is configured to measure a temperature of food materials. The control system is electrically connected to the vacuum pump set, the heating assembly, and the temperature measuring assembly.

### CROSS REFERENCE TO RELATED APPLICATIONS

The present application claims the benefit of Chinese Pat. Application No. 202210478761.2 filed on Apr. 29, 2022, the contents of which are incorporated herein by reference in their entirety.

### TECHNICAL FIELD

The present disclosure relates to the technical field of vacuum cooking, and in particular, to an integrated multifunctional vacuum cooking machine.

### BACKGROUND

Sous Vide (under vacuum) is an innovative cooking technique that yields impressive results. It refers to the process of vacuum-sealing food in a bag, then cooking it to a very precise temperature in a water bath. This technique produces results that are impossible to achieve through any other cooking method. This technique can minimize the loss of moisture and weight of the food materials during cooking, retain the original flavor and nutrients of the food, realize the standardization of cooking skills, reduce the labor cost of catering companies, and achieve a better cooking effect for beginners.

However, it should be noted that to complete the vacuum cooking of the food materials, it is necessary to prepare a vacuum packaging machine and a constant-low-temperature cooking machine. The vacuum machine and vacuum bag can keep the food in a vacuum state, and the constant-low-temperature cooking machine completes the low-temperature heating of the food materials. Obviously, the complicated cooking process takes a long time, has a high cost, and always goes with a poor cooking experience. In addition, the long-term operation requires a large amount of vacuum bags and water, which is not conducive to environmental protection. Furthermore, after the food materials are vacuum-packaged and heated in the cooking machine, the users cannot know the specific temperature of the food materials in time. Instead, they can only estimate the temperature of the food materials by measuring the temperature of the water in the cooking machine, which makes it impossible to achieve accurate control of low-temperature cooking. In addition, some food materials need to be taken out of the vacuum packaging bag after being heated in a water bath, and their surfaces should be fried and roasted. At this time, some other devices such as a spray gun, a frying pan, an oven or a toaster are also required, which further complicates the production process, increases the production cost, and compromises the user experience.

In view of the deficiencies of the prior art, there is an urgent need for an integrated multifunctional cooking machine that combines a vacuum preservation process with a low-temperature cooking process to improve the limitations of the existing Sous Vide process.

### SUMMARY

To solve the above technical problems, an objective of the present disclosure is to provide an integrated multifunctional vacuum cooking machine, having advantages such as ingenious structural design and excellent cooking effect.

On this basis, the present disclosure provides an integrated multifunctional vacuum cooking machine, including:
a cooking machine body provided with a heat conducting container configured to accommodate food materials, where the cooking machine body and the heat conducting container define a vacuum cavity configured to process the food materials;
a vacuum pump set provided on the cooking machine body and communicated with the vacuum cavity;
a heating assembly provided on the cooking machine body and configured to heat the vacuum cavity;
a temperature measuring assembly provided on the cooking machine body and configured to measure a temperature of the food materials; and
a control system provided on the cooking machine body and electrically connected to the vacuum pump set, the heating assembly, and the temperature measuring assembly.

In some embodiments of the present disclosure, the cooking machine body includes a base and a top cover, a chamber recessed downward is formed in a top surface of the base, the heat conducting container is disposed in the chamber, the top cover is configured to open and close the chamber, and the top cover and the heat conducting container define the vacuum cavity when the top cover closes the chamber.

In some embodiments of the present disclosure, the integrated multifunctional vacuum cooking machine further includes a sealing ring configured to seal the vacuum cavity, where the sealing ring is disposed on the top cover or the base.

In some embodiments of the present disclosure, the temperature measuring assembly includes a temperature measuring probe capable of being directly inserted into the food materials.

In some embodiments of the present disclosure, the temperature measuring probe is disposed on and movably connected to the top cover.

In some embodiments of the present disclosure, the temperature measuring assembly further includes a temperature measuring probe provided below the heat conducting container.

In some embodiments of the present disclosure, a handle is provided on an edge of the heat conducting container.

In some embodiments of the present disclosure, the heating assembly includes an electromagnetic heating coil located below the heat conducting container.

In some embodiments of the present disclosure, a plurality of heat dissipation areas are provided at a bottom of the base.

In some embodiments of the present disclosure, an observation window is formed in a surface of the top cover, and a transparent sealing plate covering the observation window is provided at a top of the top cover.

In some embodiments of the present disclosure, the transparent sealing plate is made of a PP material or a PC material.

Compared with the prior art, the integrated multifunctional vacuum cooking machine provided in the embodiments of the present disclosure has the following beneficial effects:

The present disclosure provides an integrated multifunctional vacuum cooking machine, including a cooking machine body, and a vacuum pump set, a heating assembly, a temperature measuring assembly and a control system provided on the cooking machine body. The cooking machine body has a vacuum cavity, and a heat conducting container is provided in the vacuum cavity. Specifically, the cooking machine body of the present disclosure includes a base and a top cover hinged to each other. A chamber recessed downward is formed in a top surface of the base, and the top cover is configured to open and close the chamber. The base and the top cover are combined to form the vacuum cavity when the top cover closes the chamber. The heat conducting container is disposed in the chamber. The vacuum pump set is disposed in the base and communicated with the vacuum cavity. The heating assembly is disposed in the base and configured to heat the vacuum cavity. The temperature measuring assembly is disposed in the base and configured to measure a temperature in the vacuum cavity and a temperature of food materials. The control system is disposed on the base and electrically connected to the vacuum pump set, the heating assembly, and the temperature measuring assembly. Based on the above structures, when cooking, a user puts the prepared food materials and seasonings into the heat conducting container, opens the top cover, arranges the heat conducting container in the chamber, closes the top cover to seal the vacuum cavity, and waits for a period of time to complete the pickling of the food materials. After that, the vacuum pump set is started to suction air in the vacuum cavity to make the vacuum cavity reach a specified vacuum degree, then the operation of the vacuum pump set is stopped, and the heating assembly is started to continuously and stably heat the heat conducting container at low temperature. At this time, the food materials in the heat conducting container are also continuously and stably heated at low temperature under the heat transfer of the heat conducting container, thereby achieving low-temperature vacuum cooking of the food materials. After the heating is completed, the vacuum pump set is turned on to inflate the vacuum cavity to make the pressure of the vacuum cavity return to an ambient pressure. The top cover is open to take out the food materials. Of course, the user can also choose to activate the heating assembly to heat the food materials in the heat conducting container at high temperature to complete operations such as frying and roasting of the food materials. In this way, the integrated multifunctional vacuum cooking machine is ingenious in structural design, can simultaneously complete low-temperature vacuum cooking of the food materials, and achieves a plurality of purposes. Furthermore, the present disclosure further improves the existing vacuum packaging process and low-temperature cooking process, and vacuum packaging bags are no longer needed for packaging the food materials during vacuum packaging, thereby reducing operations such as bagging and unpacking. Low-temperature heating no longer uses a water bath to heat, but directly uses the heating assembly to heat the food materials in the heat conducting container to achieve water-free low-temperature vacuum cooking of the food materials, thereby effectively improving the existing low-temperature vacuum cooking process, and improving the cooking experience of users.

### BRIEF DESCRIPTION OF THE DRAWINGS

FIG. 1 is a schematic structural diagram of an integrated multifunctional vacuum cooking machine according to an embodiment of the present disclosure;

FIG. 2 is a schematic structural diagram of a top cover of an integrated multifunctional vacuum cooking machine according to an embodiment of the present disclosure; and

FIG. 3 is a schematic structural diagram of a base of an integrated multifunctional vacuum cooking machine according to an embodiment of the present disclosure.

In the figures, 1. Top cover; 11. Sealing ring; 12. Observation window; 13. Transparent sealing plate; 2. Base; 21. Chamber; 22. Heat dissipation area; 23. Cooling fan; 24. Temperature measuring probe; 3. Heat conducting container; 31. Handle; 4. Vacuum pump set; 5. Heating assembly; 51. Electromagnetic heating coil; 6. Temperature measuring assembly; 61. Temperature measuring probe; 7. Control system; 8. Cooking machine body; and 9. Vacuum cavity.

### DETAILED DESCRIPTION

The specific implementations of the present disclosure are described in more detail below with reference to the accompanying drawings and embodiments. The following embodiments are illustrative of the present disclosure and should not be construed as limiting of the scope of the present disclosure.

It should be understood that the terms such as “front”, “back”, and the like are used in the present invention to describe various information, but the information should not be limited to these terms, and these terms are only used to distinguish the same type of information from each other. For example, without departing from the scope of the present disclosure, “front” information may be referred to as “back” information, and “back” information may also be referred to as “front” information.

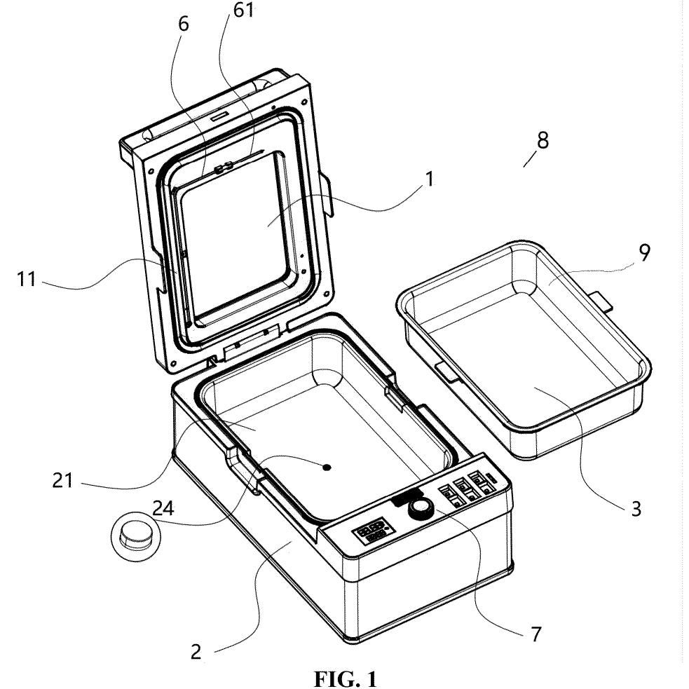

As shown in FIG. 1 to FIG. 3, the present disclosure provides an integrated multifunctional vacuum cooking machine, including a cooking machine body 8, and a vacuum pump set 4, a heating assembly 5, a temperature measuring assembly 6 and a control system 7 provided on the cooking machine body 8. The cooking machine body 8 is provided with a heat conducting container 3 configured to accommodate food materials. The cooking machine body 8 and the heat conducting container define a vacuum cavity 9 configured to cook the food materials. Specifically, in the embodiments of the present disclosure, the cooking machine body 8 includes a base 2 and a top cover 1 hinged to each other. A chamber 21 recessed downward is formed in a top surface of the base 2. The heat conducting container 3 is disposed in the chamber 21. The top cover 1 is configured to open and close the chamber 21. The heat conducting container 3 and the top cover 1 define the vacuum cavity 9 when the top cover 1 closes the chamber 21. The vacuum pump set 4 is disposed in the base 2 and communicated with the vacuum cavity 9. The heating assembly 5 is disposed in the base 2 and configured to heat the vacuum cavity 9. The temperature measuring assembly 6 is disposed in the base 2 and configured to measure a temperature in the vacuum cavity 9 and a temperature of the food materials. The control system 7 is disposed on the base 2 and electrically connected to the vacuum pump set 4, the heating assembly 5, and the temperature measuring assembly 6.

Based on the above structures, when cooking, a user puts the prepared food materials and seasonings into the heat conducting container 3, opens the top cover 1, arranges the heat conducting container 3 in the chamber 21, closes the top cover 1 to seal the vacuum cavity 9, and waits for a period of time to complete the pickling of the food materials. After that, the vacuum pump set 4 is started to suction air in the vacuum cavity 9 to make the vacuum cavity 9 reach a specified vacuum degree, and the specified vacuum degree is generally selected within a range of 0-700 mmHg. Then the operation of the vacuum pump set 4 is stopped, and the heating assembly 5 is started to continuously and stably heat the heat conducting container 3 at low temperature. At this time, the food materials in the heat conducting container 3 are also continuously and stably heated at low temperature under the heat transfer of the heat conducting container 3, thereby achieving low-temperature vacuum cooking of the food materials. After the heating is completed, the vacuum pump set 4 is turned on to inflate the vacuum cavity 9 to make the pressure of the vacuum cavity 9 return to an ambient pressure. The top cover 1 is open to take out the food materials. Of course, the user can also choose to activate the heating assembly 5 to heat the food materials in the heat conducting container 3 at high temperature to complete operations such as frying and roasting of the food materials. In this way, the integrated multifunctional vacuum cooking machine is ingenious in structural design, can simultaneously complete vacuum preservation and low-temperature cooking of the food materials, and achieves a plurality of purposes. Furthermore, the present disclosure further improves the existing vacuum packaging process and low-temperature cooking process, and vacuum packaging bags are no longer needed for packaging the food materials during vacuum packaging, thereby reducing operations such as bagging and unpacking. Low-temperature heating no longer uses a water bath to heat, but directly uses the heating assembly 5 to heat the food materials in the heat conducting container 3 to achieve water-free low-temperature vacuum cooking of the food materials, thereby effectively improving the existing low-temperature vacuum cooking process, and improving the cooking experience of users.

Of course, the base 2 and the top cover 1 can be connected in a variety of ways and are not limited to the hinged connection, and the two can also be connected by buckling or clamping.

Furthermore, for the vacuum pump set and the vacuum cavity 9 in the present application, the vacuum pump set 4 is communicated with the vacuum cavity 9 through a pipeline. To ensure the suction effect of the vacuum pump set 4, it is necessary to form, in the top cover 1 or the base 2 that forms the vacuum cavity 9, a suction hole communicated with the pipeline of the vacuum pump set 4. Specifically, in the embodiments of the present disclosure, the suction hole (not shown in the figures) communicated with the pipeline of the vacuum pump set 4 is formed in the top cover 1. Since the heat conducting container is mostly made of stainless steel or a composite metal plate, only the pressure-bearing requirement of the plastic top cover 1 needs to be considered at this time. This structural design is simpler, the production is easy, and the control of production cost is facilitated. Of course, in the other embodiments of the present disclosure, it is also possible to choose to form, in the base 2, the suction hole communicated with the pipeline of the vacuum pump set 4. At this time, to ensure the suction effect, it is necessary to design a connection structure between the base 2 and the inside of the heat conducting container 3, and meanwhile, it is necessary to take into account the pressure-bearing requirements of the top cover 1 and the base 2 and choose a material having a better pressure-bearing effect to manufacture the base 2.

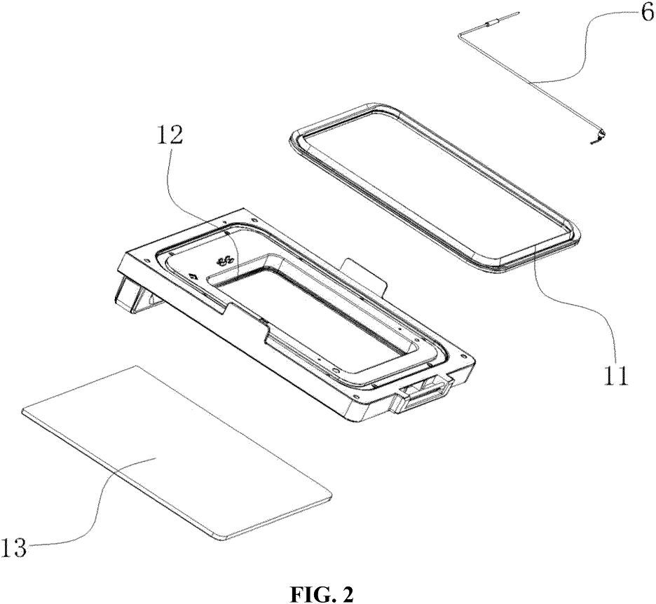

Optionally, to improve the sealing effect on the vacuum cavity 9 and ensure the vacuum degree of the vacuum cavity 9, as shown in FIG. 1 and FIG. 2, in some embodiments of the present disclosure, a sealing ring 11 around an edge of the heat conducting container 3 is provided at the bottom of the top cover 1. It should be noted that to improve the sealing effect of the sealing ring 11, the setting position of the sealing ring 11 can also be adjusted according to the setting form of the heat conducting container 3. Specifically, in the other embodiments of the present disclosure, the sealing ring 11 can also be disposed at the top of the base 2.

Furthermore, to accurately measure the temperature of the food materials, the temperature measuring assembly 6 may have various structural design forms. Specifically, as shown in FIG. 1 and FIG. 2, in the embodiments of the present disclosure, the temperature measuring assembly 6 includes a temperature measuring probe 61 provided on the top cover 1. The temperature measuring probe 61 is movably connected to the top cover 1 and can move in the vacuum cavity 9 according to an instruction of the control system 7. In the past, when the food materials are heated in a water bath at low temperature, the temperature measuring assembly 6 is usually selected to measure the temperature of each part of the water, and the temperature of the food materials is comprehensively confirmed according to the temperature of the water in a water bath pot. However, for the present disclosure, due to the improvement of the structure of the cooking machine and the cooking process, the food materials of the present disclosure are not vacuum-sealed in vacuum packaging bags but are directly placed in the heat conducting container 3. Therefore, the temperature measuring probe 61 can be directly inserted into the food materials to accurately measure the center temperature of the food materials during the low-temperature heating process. The structural design is reliable and ingenious, and the temperature measuring probe 61 has high measurement accuracy and small measurement error.

Furthermore, in some embodiments of the present disclosure, the temperature measuring assembly 6 further includes a temperature measuring probe 24 provided below the heat conducting container 3. The temperature measuring probe 24 can monitor the temperature of the heat conducting container 3, thereby avoiding the damage of the heat conducting container 3 by long-time heating, prolonging the service life of the heat conducting container 3, and then prolonging the service life of the integrated multifunctional cooking machine.

Of course, the setting position of the temperature measuring probe 61 in the present disclosure should also not be fixed. To obtain a better temperature measuring effect, the mounting position of the temperature measuring probe 61 can be adjusted according to specific situations. That is, the temperature measuring probe 61 can be disposed on the top cover 1 or the base 2. Moreover, to better achieve temperature measurement and transfer of the temperature measuring probe 61, part of the temperature measuring probe 61 can also be electrically connected to the control system 7 by means of a wireless sensing structure such as a Bluetooth module. The control system 7 may be one or more controllers that have a communication interface to implement a communication protocol, and may further include a memory and relevant interfaces, a system transmission bus, and the like if necessary. The wireless sensing structure may be a chip integrated with communication interfaces and basic circuits.

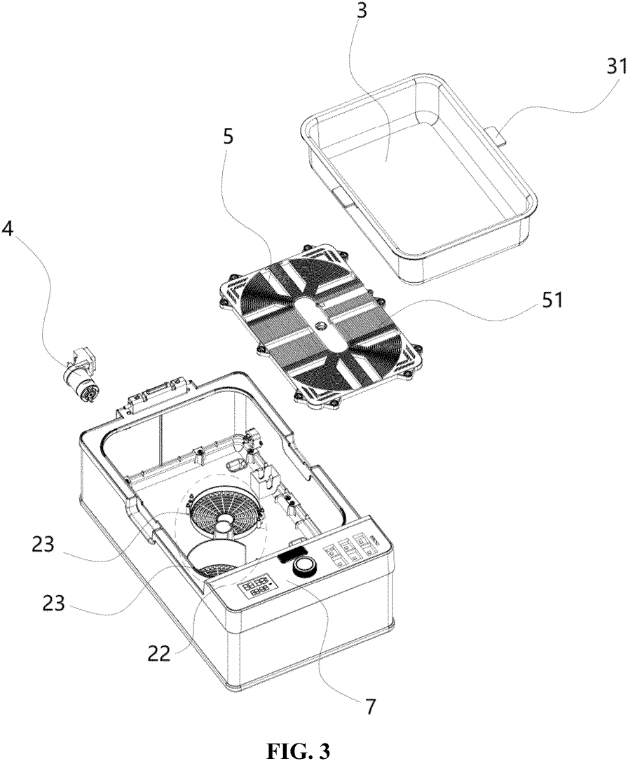

Optionally, as shown in FIG. 3, in some embodiments of the present disclosure, to facilitate the operation of the user, a handle 31 is provided on an edge of the heat conducting container 3, and the user can complete the lifting and placement of the heat conducting container 3 through the handle 31, such that the structural design is ingenious, and the use experience is good.

Furthermore, the heating assembly 5 of the present disclosure also includes a plurality of structural designs. Specifically, in the embodiments of the present disclosure, as shown in FIG. 3, the heating assembly 5 includes an electromagnetic heating coil 51, which is provided below the heat conducting container 3, and can heat the heat conducting container 3, thereby heating the food materials in the heat conducting container 3. Of course, to achieve a better heating effect of the heat conducting container 3 and the vacuum cavity 9, the setting position of the electromagnetic heating coil 51 can also be adjusted. That is, the electromagnetic heating coil 51 of the heating assembly 5 can also be disposed beside the heat conducting container 3. In the present disclosure, arranging the electromagnetic heating coil 51 below the heat conducting container 3 is also a preferred result after repeated trials and tests.

Furthermore, a plurality of heat dissipation areas 22 are provided at the bottom of the base 2 on the basis of the settings of the heat conducting container 3 and the electromagnetic heating coil 51. Some of the heat dissipation areas 22 are provided with cooling fans 23. When the heating assembly 5 is started, the cooling fans 23 are started at the same time, which can effectively reduce the temperature of the electromagnetic heating coil 51, thereby avoiding the influence of overheating on normal use of the cooking machine.

In addition, in some embodiments of the present disclosure, an observation window 12 is formed in a surface of the top cover 1. The user can visually understand the situation in the vacuum cavity 9 in time through the observation window 12, and determine the cooking degree of the food materials. Obviously, to ensure the sealing and observation effect, a transparent sealing plate 13 covering the observation window 12 is provided at the top of the top cover 1. Specifically, in some embodiments of the present disclosure, the transparent sealing plate 13 is made of a PP material or a PC material. The raw material is common and easily available, the manufacturing is convenient, and the cost control is facilitated.

In conclusion, the present disclosure provides an integrated multifunctional vacuum cooking machine, including a cooking machine body, and a heat conducting container, a vacuum pump set, a heating assembly, a temperature measuring assembly and a control system provided on the cooking machine body. The cooking machine body includes a base and a top cover hinged to each other. A chamber recessed downward is formed in a top surface of the base, and the top cover is configured to open and close the chamber. The top cover and the heat conducting container define a vacuum cavity when the top cover closes the chamber. The vacuum pump set is disposed in the base and communicated with the vacuum cavity. The heating assembly is disposed in the base and configured to heat the vacuum cavity. The temperature measuring assembly is disposed in the base and configured to measure a temperature in the vacuum cavity and a temperature of food materials. The control system is disposed on the base and electrically connected to the vacuum pump set, the heating assembly, and the temperature measuring assembly. Compared with the prior art, the integrated multifunctional vacuum cooking machine is ingenious in structural design, can simultaneously complete vacuum preservation and low-temperature cooking of the food materials, and achieves a plurality of purposes. Furthermore, the present disclosure further improves the existing vacuum packaging process and low-temperature cooking process, and vacuum packaging bags are no longer needed for packaging the food materials during vacuum packaging, thereby reducing operations such as bagging and unpacking. Low-temperature heating no longer uses a water bath to heat, but directly uses the heating assembly to heat the food materials in the heat conducting container to achieve water-free low-temperature vacuum cooking of the food materials, thereby effectively improving the existing low-temperature vacuum cooking process, and improving the cooking experience of users.

The foregoing are merely descriptions of the preferred embodiments of the present disclosure. It should be noted that several improvements and replacements can be made by a person of ordinary skill in the art without departing from the technical principle of the present disclosure, and these improvements and replacements shall also be deemed as falling within the protection scope of the present disclosure.

1. An integrated multifunctional vacuum cooking machine, comprising:
a cooking machine body provided with a heat conducting container configured to accommodate food materials, wherein the cooking machine body and the heat conducting container define a vacuum cavity configured to process the food materials;
a vacuum pump set provided on the cooking machine body and communicated with the vacuum cavity;
a heating assembly provided on the cooking machine body and configured to heat the food materials in the vacuum cavity through the heat conducting container;
a temperature measuring assembly provided on the cooking machine body and configured to measure a temperature of the food materials; and
a control system provided on the cooking machine body and electrically connected to the vacuum pump set, the heating assembly, and the temperature measuring assembly.

2. The integrated multifunctional vacuum cooking machine according to claim 1, wherein the cooking machine body comprises a base and a top cover, a chamber recessed downward is formed in a top surface of the base, the heat conducting container is disposed in the chamber, the top cover is configured to open and close the chamber, and the top cover and the heat conducting container define the vacuum cavity when the top cover closes the chamber.

3. The integrated multifunctional vacuum cooking machine according to claim 2, further comprising a sealing ring configured to seal the vacuum cavity, wherein the sealing ring is disposed on the top cover or the base.

4. The integrated multifunctional vacuum cooking machine according to claim 2, wherein the temperature measuring assembly comprises a temperature measuring probe provided in the vacuum cavity, and is electrically connected to the control system and capable of being directly inserted into the food materials.

5. The integrated multifunctional vacuum cooking machine according to claim 4, wherein the temperature measuring probe is disposed on the base or the top cover.

6. The integrated multifunctional vacuum cooking machine according to claim 4, wherein the temperature measuring assembly further comprises a temperature measuring probe provided below the heat conducting container.

7. The integrated multifunctional vacuum cooking machine according to claim 2, wherein a handle is provided on an edge of the heat conducting container.

8. The integrated multifunctional vacuum cooking machine according to claim 2, wherein the heating assembly comprises an electromagnetic heating coil located below the heat conducting container and located outside the chamber.

9. The integrated multifunctional vacuum cooking machine according to claim 8, wherein a plurality of heat dissipation areas are provided at a bottom of the base.

10. The integrated multifunctional vacuum cooking machine according to claim 2, wherein an observation window is formed in a surface of the top cover, and a transparent sealing plate covering the observation window is provided at a top of the top cover.
